(19) United States
(12) Patent Application Publication
(10) Pub. No.: US 2022/0340403 A1
(43) Pub. Date: Oct. 27, 2022

(54) Telescoping Jib with An Extended Envelope

(71) Applicants: ZOOMLION Heavy Industry NA, Inc., Yorkville, WI (US); ZOOMLION Heavy Industry Science and Technology Co. Ltd., Changsha Hunan Province (CN)

(72) Inventors: Matthew Schoenberg, Kenosha, WI (US); Edgar Calago, Lake Villa, IL (US)

(21) Appl. No.: 17/240,048

(22) Filed: Apr. 26, 2021

(51) Int. Cl. B66F 11/04

(52) U.S. Cl. CPC B66F 11/046; B66C 23/702

(57) ABSTRACT

A telescoping jib with an extended envelope preferably includes a telescopic boom, a telescopic jib boom and an electronic control module. A bottom of the telescopic boom is pivotally engaged with a base movable member. A top of the telescopic boom is pivotally engaged with a bottom of the telescopic jib boom. The telescopic jib boom includes a jib rotator assembly, a jib telescoping member, a basket rotator assembly and a user basket. The jib rotator assembly and a jib hydraulic cylinder are used to change an angle of the telescopic jib member. The basket rotator assembly is secured to a top end of the telescopic jib member. The user basket is retained by basket rotator assembly. A software program in the electronic control module is modified such that, a bottom of the jib rotatory assembly is tilted counter clockwise by about 10 degrees to create an extended envelope.

### BACKGROUND OF THE INVENTION

### 1. Field of the Invention

The present invention relates generally to heavy equipment and more specifically to an telescoping jib with an extended envelope, which includes tilting a jib rotator assembly counter clockwise to obtain the extended envelope.

### 2. Discussion of the Prior Art

Telescoping jibs include a telescopic boom and a telescopic jib boom. A bottom of the telescopic boom is pivotally retained by a base movable member. A jib rotator assembly connects a top of the telescopic boom with a bottom of the telescopic jib boom. A basket rotator assembly is retained on a top of the top of the telescopic jib boom. The basket rotator assembly retains an operator basket. The operation of the telescoping jib is controlled by a user in the user basket. It is desirable for the telescoping jib to have the greatest outer envelope. Telescoping jibs are well known in the art and need not be explained in further detail. Most manufacturers use control software that always keeps a bottom of the jib rotator assembly level with respect to the ground using gravity based level sensors on the user basket and jib rotator assembly. Patent publication no. 2018/0057330 to XU discloses a telescopic connection component and aerial work platform.

Accordingly, there is a clearly felt need in the art for an telescoping jib with an extended envelope, which includes tilting a jib rotator assembly counter clockwise about 10 degrees to obtain the extended envelope.

### SUMMARY OF THE INVENTION

The present invention provides an telescoping jib with an extended envelope, which includes tilting a jib rotator assembly counter clockwise to obtain the extended envelope. The telescoping jib with an extended envelope preferably includes a telescopic boom, a telescopic jib boom and an electronic control module. A bottom of the telescopic boom is pivotally retained by a base movable member. A top of the telescopic boom includes a boom hydraulic cylinder. A jib rotator assembly of the telescopic jib boom is pivotally connected to the top of the telescopic boom. The jib rotator assembly is pivoted with the boom hydraulic cylinder. Actuation of the boom hydraulic cylinder extending from the telescopic boom controls an angle of the jib rotator assembly relative to the ground. A bottom of the telescopic jib boom is pivotally retained by the jib rotator assembly. One end of a jib hydraulic cylinder is pivotally retained by the jib rotator assembly and the other end is pivotally retained by the telescopic jib boom. An angle of the telescopic jib boom is controlled by actuation of the jib hydraulic cylinder.

The basket rotator assembly includes a basket bracket, a basket rotator and a bracket hydraulic cylinder. The basket bracket is retained on a top of the telescopic jib boom. The basket rotator is pivotally retained by the basket bracket. One end of the basket hydraulic cylinder is pivotally retained by the basket bracket. An opposing end of the basket cylinder is pivotally retained on the basket rotator. The basket is retained on an end of the basket rotator. Actuation of the basket cylinder keeps a basket floor of the user basket level with the ground. A basket sensor is used to provide feedback of whether the basket floor is level relative to the ground. A jib rotator sensor provides an output of an angle of the jib rotatory assembly. The electronic control module includes a software program. The electronic control module receives input from the jib rotator sensor and the basket sensor. The electronic control module sends signals to a boom control valve to raise or lower the boom cylinder and a basket control valve to raise or lower the basket cylinder, such that the jib boom is 85 degrees counter clockwise relative to ground and the basket floor is level with the ground.

Accordingly, it is an object of the present invention to provide a telescoping jib with an extended envelope, which includes tilting a jib rotator assembly counter clockwise about 10 degrees to obtain the extended envelope.

These and additional objects, advantages, features and benefits of the present invention will become apparent from the following specification.

### BRIEF DESCRIPTION OF THE DRAWINGS

FIG. 1 is a side view of a telescoping jib with a normally oriented jib boom and a jib boom that has been titled counter clockwise by an angle B in accordance with the present invention.

FIG. 2 is a side view of a normally oriented telescopic jib boom of a telescoping jib.

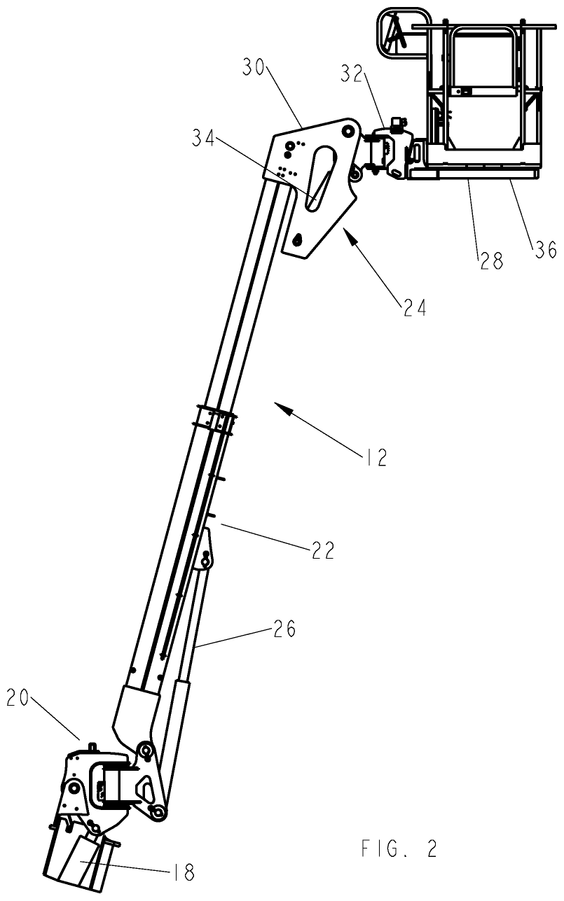

FIG. 3 is a side view of a telescopic jib boom that has been titled counter clockwise relative to the ground by an angle B of a telescoping jib with an extended envelope in accordance with the present invention.

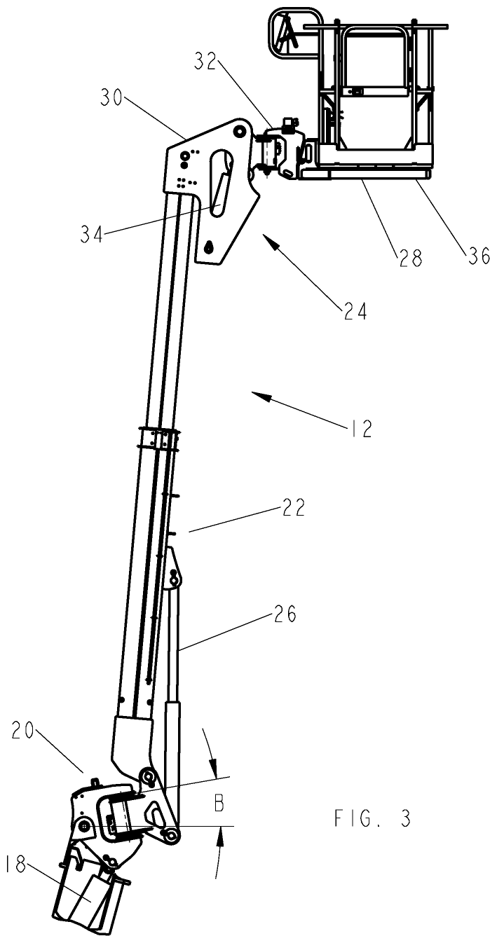

FIG. 4 is a schematic diagram of components connected to an electronic control module of a telescoping jib with an extended envelope in accordance with the present invention.

### DETAILED DESCRIPTION OF THE PREFERRED EMBODIMENTS

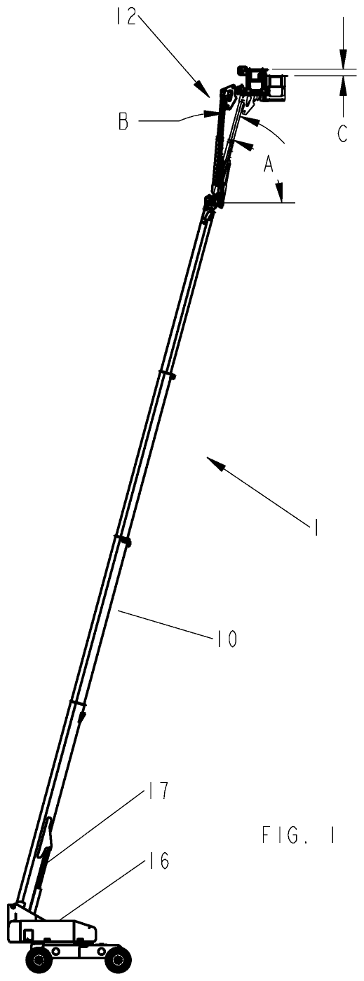

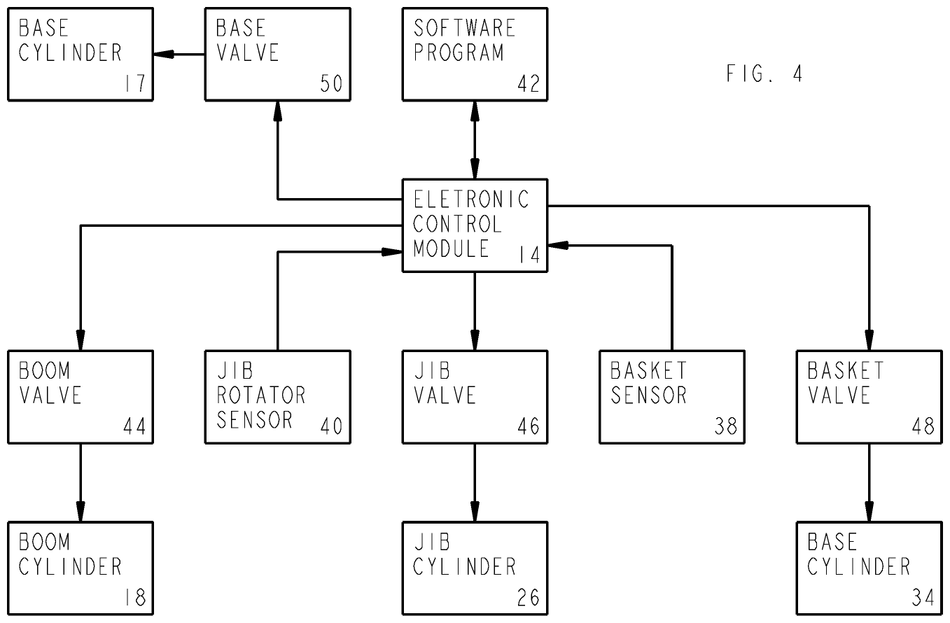

With reference now to the drawings, and particularly to FIG. 1, there is shown a side view of a telescopic jib boom of a telescoping jib with an extended envelope 1 that has been rotated counter clockwise by an angle “B.” With reference to FIG. 4, the telescoping jib with an extended envelope 1 preferably includes a telescopic boom 10, a telescopic jib boom 12 and an electronic control module 14. A bottom of the telescopic boom 10 is pivotally retained by a base movable member 16. A base hydraulic cylinder 17 includes one end pivotally engaged with the base movable member 16 and an opposing end pivotally engaged with the telescopic boom 10. Actuation of the base hydraulic cylinder 17 tilts the telescopic boom 10.

One end of a boom hydraulic cylinder 18 is pivotally engaged with a top end of the telescopic boom 10. A jib rotator assembly 20 of the telescopic jib boom 12 is pivotally engaged with the top of the telescopic boom 10. An opposing end of the boom hydraulic cylinder 18 is pivotally engaged with the jib rotator assembly 20. The jib rotator assembly 20 is tilted with the boom hydraulic cylinder 18. The telescopic jib boom 12 includes the jib rotator assembly 20, a jib telescopic member 22, a basket rotator assembly 24 a jib hydraulic cylinder 26 and a user basket 28. Actuation of the boom hydraulic cylinder 18 controls an angle of a bottom of the jib rotator assembly 20 relative to the ground. A bottom of the jib telescopic member 22 is pivotally retained by the jib rotator assembly 20. One end of the jib hydraulic cylinder 26 is pivotally retained by the jib rotator assembly 20 and the other end is pivotally retained by the jib telescopic member 22. An angle of the jib telescopic member 22 is controlled by actuation of the jib hydraulic cylinder 26.

The basket rotator assembly 24 includes a basket bracket 30, a basket rotator 32 and a bracket hydraulic cylinder 34. The basket bracket 30 is retained on a top of the jib telescoping member 22. The basket rotator 32 is pivotally retained by the basket bracket 30. One end of the basket hydraulic cylinder 34 is pivotally retained by the basket bracket 30. An opposing end of the basket hydraulic cylinder 34 is pivotally retained on the basket rotator 32. The user basket 28 is retained on an end of the basket rotator 32. Actuation of the basket hydraulic cylinder 34 keeps a basket floor 36 of the basket 28 level with the ground.

With reference to FIG. 4, a basket sensor 38 is used to provide an output of whether the basket floor 36 is level relative to the ground. A jib rotator sensor 40 provides an output of an angle of a bottom of the jib rotatory assembly 20. The electronic control module 14 includes a software program 42. The electronic control module 14 receives input from the jib rotatory sensor 40 and the basket sensor 38. The electronic control module 14 sends a signal to a boom control valve 44 to raise or lower the boom hydraulic cylinder 18; a signal to a jib control valve 46 to raise or lower the jib hydraulic cylinder 26; and a signal to a basket control valve 48 to raise or lower the basket hydraulic cylinder 34, such that the angle “A” of the jib telescoping member is preferably about 85 degrees counter clockwise relative to ground and the basket floor 36 is level with the ground. The electronic control module 14 is also used to raise or lower the base cylinder 17 with a base control valve 50. The software program 42 is modified such that a bottom of the jib rotator assembly 20 preferably has angle “B” of about 10 degrees relative to the ground. Tilting the jib rotator assembly 20 counter clockwise 10 degrees increases an upper envelope of the telescoping jib 1 by dimension “C.” Dimension “C” has a value of one foot with the 10 degree tilt of the jib rotator assembly 20.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

We claim:

1. A telescoping jib with extended envelope, comprising:
a telescopic boom;
a jib rotator assembly is pivotally engaged with a top end of said telescopic boom;
a boom cylinder includes one end pivotally engaged with said telescoping boom and an opposing end pivotally engaged with said jib rotator assembly;
a telescopic jib member includes a bottom end pivotally engaged with said jib rotator assembly;
a basket rotator assembly is retained on a top end of said telescopic jib member;
a basket is retained by said basket rotator assembly; and
an electronic control module is programmed to make a floor of said basket level relative to the ground, a bottom of said jib rotator assembly is titled counter clockwise about 10 degrees to obtain the extended envelope.

2. The telescoping jib with extended envelope of claim 1, further comprising:
said electronic control module includes a software program, said software program is modified to tilt said bottom of said jib rotator assembly about 10 degrees.

3. The telescoping jib with extended envelope of claim 1, further comprising:
a jib cylinder includes a bottom end pivotally engaged with said jib rotator assembly and an opposing end engaged with said telescopic jib member.

4. The telescoping jib with extended envelope of claim 1, further comprising:
said basket rotator assembly includes a basket bracket, a basket rotator and a bracket cylinder, said basket bracket is retained on a top end of said jib telescopic member, said basket rotator is pivotally retained by said basket bracket, one end of said basket cylinder is pivotally retained by said basket bracket, an opposing end of said basket cylinder is pivotally retained on said basket rotator.

5. The telescoping jib with extended envelope of claim 1 wherein:
said electronic control module operates a boom control valve, a jib control valve and a basket control valve, said boom control valve controls flow to said boom cylinder, said jib control valve controls flow to a jib cylinder, said basket control valve controls flow to a basket cylinder.

6. A telescoping jib with extended envelope comprising:
a movable base;
a telescopic boom includes a bottom end pivotally engaged with said movable base;
a jib rotator assembly is pivotally engaged with a top end of said telescopic boom;
a boom cylinder includes one end pivotally engaged with said telescopic boom and an opposing end pivotally engaged with said jib rotator assembly;
a telescopic jib member includes a bottom end pivotally engaged with said jib rotator assembly;
a basket rotator assembly is pivotally engaged with a top end of said telescopic jib member;
a basket is retained by said basket rotator assembly; and
an electronic control module is programmed to make a floor of said basket parallel with the ground, a bottom of said jib rotator assembly is titled counter clockwise about 10 degrees to obtain the extended envelope.

7. The telescoping jib with extended envelope of claim 6, further comprising:
said electronic control module includes a software program, said software program is modified to tilt a bottom of said jib rotator assembly about 10 degrees.

8. The telescoping jib with extended envelope of claim 6, further comprising:
a jib cylinder includes a bottom end pivotally engaged with said jib rotator assembly and an opposing end engaged with said telescoping jib member.

9. The telescoping jib with extended envelope of claim 6, further comprising:
said basket rotator assembly includes a basket bracket, a basket rotator and a bracket cylinder, said basket bracket is retained on a top end of said jib telescopic member, said basket rotator is pivotally retained by said basket bracket, one end of said basket cylinder is pivotally retained by said basket bracket, an opposing end of said basket cylinder is pivotally retained on said basket rotator.

10. The telescoping jib with extended envelope of claim 6, further comprising:
a base cylinder includes one end pivotally engaged with said moveable base, an opposing end of said base cylinder is pivotally engaged with said telescopic boom.

11. The telescoping jib with extended envelope of claim 6 wherein:
said electronic control module operates a boom control valve, a jib control valve and a basket control valve, said boom control valve controls flow to said boom cylinder, said jib control valve controls flow to a jib cylinder, said basket control valve controls flow to a basket cylinder.

12. The telescoping jib with extended envelope of claim 6 wherein:
said electronic control module operates a base control valve, said base control valve controls flow to a base cylinder.

13. A method of extending an envelope of a telescoping jib, said telescoping jib including a telescopic boom, a boom cylinder, a telescopic jib member, a jib rotator assembly, a basket rotator assembly and a basket, said jib rotator assembly is pivotally engaged with a top end of said telescoping boom, said boom cylinder includes one end pivotally engaged with said telescoping boom, an opposing end of said telescoping boom is pivotally engaged with said jib rotator assembly, said telescoping jib member includes a bottom end pivotally engaged with said jib rotator assembly, said basket rotator assembly is retained on an opposing end of said telescopic jib member, basket is retained on said basket rotator assembly, comprising the steps of:
providing an electronic control module having a software program; and
writing the software program to tilt a bottom of said jib rotator assembly counter clockwise about 10 degrees relative to the ground, while maintaining a floor of said basket level with the ground to increase a vertical height of said basket by about one foot.

14. The method of extending an envelope of a telescoping jib of claim 13, further comprising the step of:
providing a jib cylinder having a bottom end pivotally engaged with said jib rotator assembly and an opposing end engaged with said telescoping jib member.

15. The method of extending an envelope of a telescoping jib of claim 13, further comprising the step of:
providing said basket rotator assembly with a basket bracket, a basket rotator and a bracket cylinder, said basket bracket is retained on a top end of said telescopic jib member, said basket rotator is pivotally retained by said basket bracket, one end of said basket cylinder is pivotally retained by said basket bracket, an opposing end of said basket cylinder is pivotally retained on said basket rotator.

16. The method of extending an envelope of a telescoping jib of claim 13, further comprising the step of:
using said electronic control module to operate a boom control valve, a jib control valve and a basket control valve, said boom control valve controls flow to a boom cylinder, said jib control valve controls flow to a jib cylinder, said basket control valve controls flow to a basket cylinder.
